(19) United States
(12) Patent Application Publication
(10) Pub. No.: US 2025/0043098 A1
(43) Pub. Date: Feb. 6, 2025

(54) DEVICE AND METHOD FOR PRODUCING A POLYESTER DEPOLYMERIZATE, AND DEVICE AND METHOD FOR PRODUCING A POLYESTER

(71) Applicants: Uhde Inventa-Fischer GmbH, Berlin (DE); thyssenkrupp AG, Essen (DE)

(72) Inventors: Matthias SCHOENNAGEL, Berlin (DE); Christopher HESS, Schoenfliess (DE); Martin HITTORFF, Bonaduz (CH); Michael SCHUBERT, Chur (CH); Alexander PAWELSKI, Felsberg (CH); Heinrich KOCH, Kleinmachnow (DE)

(73) Assignees: Uhde Inventa-Fischer GmbH, Berlin (DE); thyssenkrupp AG, Essen (DE)

(21) Appl. No.: 18/709,231

(22) PCT Filed: Nov. 3, 2022
(86) PCT No.: PCT/EP2022/080689

§ 371 Date: May 10, 2024

(30) Foreign Application Priority Data
Nov. 11, 2021 (DE) 10 2021 212 695.2

(51) Int. Cl. C08J 11/24; C08J 11/14; C08J 11/26

(52) U.S. Cl. CPC C08J 11/24; C08J 11/14; C08J 11/26; C08J 2367/02

(57) ABSTRACT

A PET recycling (the reprocessing of polyethylene terephthalate wastes) has already been practised for many decades in a variety of different ways, since PET is available in large quantities. Environmental protection and sustainability in resource utilization, however, call for ever higher recycling rates in the decades to come. If the concept of a circular economy is to be achieved, this rate must ultimately amount, sooner or later, to 100%.

PET recycling (the reprocessing of polyethylene terephthalate wastes) has already been practised for many decades in a variety of different ways, since PET is available in large quantities. Environmental protection and sustainability in resource utilization, however, call for ever higher recycling rates in the decades to come. If the concept of a circular economy is to be achieved, this rate must ultimately amount, sooner or later, to 100%.

The use of recycled PET products in the food packaging sector necessitates special recycling processes, which require approval from competent authorities.

One such approved recycling process is the chemical depolymerization and subsequent repolymerization of PET. Depolymerization may be accomplished, for example, with water (hydrolysis) or with ethylene glycol (glycolysis), in which the long-chain PET starting material is split into shorter chains (monomers, oligomers, prepolymer). The higher the fraction of water or ethylene glycol, the shorter the average chain length and the higher the cost and complexity of repolymerization. For optimized repolymerization, COOH end groups produced by hydrolysis must be re-esterified, which can be accomplished preferably with ethylene glycol. In that case the depolymerized recycled material can be polycondensed again at elevated temperature under reduced-pressure conditions in specific polycondensation apparatuses corresponding to the prior art.

### PRIOR ART

DE 10 2018 202 547 A1 specifies a process for producing a polyester using polyester recyclatepolyester recyclate flakes, where the polyester recyclatepolyester recyclate flakes are mixed in a dynamic mixer with an intermediate product stream from an intermediate stage of a virgin polyester production process and the mixture is then added again downstream into a downstream stage of the virgin polyester production process. Typical intermediate products are monomers from an esterification or post-esterification stage or prepolymers from a preliminary condensation stage. A disadvantage of this technology is the large quantity of intermediate product which is required for the mix-incorporation of the recycled material and which considerably complicates a precision filtration for quality improvement. A further disadvantage, in the case of contamination of the recycled material with extraneous substances, is the contamination of a large quantity of intermediate product and end product in the PET plant.

EP 0 942 035 B1 describes a process for recovering linear polyester, where recycled material is melted in an extruder and prepolymer is obtained by simultaneous hydrolytic and glycolytic breakdown. The melt is then supplied again for polycondensation to a virgin polyester production process. A disadvantage of this technique is the use of extruders for melting the recycled material. Extruders are limited by the capacity, have high acquisition costs, and must be operated with electrical energy.

In DE 10 2006 023 354 B4, the process from EP 0 942 035 B1 is linked with a subsequent pelletization. Here again is the disadvantage of the use of extruders for melting the recycled material.

WO 2020/149798 A1 likewise melts rPET in an extruder and then carries out glycolization with ethylene glycol (EG).

In U.S. Pat. No. 8,969,488 B2, comminuted rPET in a sidestream is mixed with paste (mixture of the raw materials terephthalic acid and ethylene glycol) in a mixer and the mixture is fed to an esterification stage. As a result of the limited possibility for mix-incorporation, it is not possible to achieve large capacities and, in the event of contamination of the recycled material with extraneous substances, again, a large amount of intermediate product and end product, and a plurality of process stages, are contaminated.

In DE 196 43 479 B4, PET wastes are split with a high EG excess in the presence of depolymerization catalysts to give BHET, and then the BHET is purified and repolymerized. This process necessitates numerous costly and inconvenient process steps and apparatuses, and is consequently expensive and inefficient.

GB 610 136 A describes the depolymerization of aromatic polyesters with ethylene glycol at the boiling temperature of ethylene glycol or a little above in a reaction tank, and the subsequent repolymerization. At these temperatures, however, the reaction rate is too low for large capacities and, when higher temperatures are used, the ethylene glycol escapes from the process.

U.S. Pat. No. 3,222,299 describes the depolymerization of linear terephthalate polyesters with ethylene glycol and metal salt catalysts in a reaction tank at the boiling temperature of ethylene glycol (196° C.), and the subsequent repolymerization. This process as well requires large amounts of ethylene glycol, which must be removed again by costly and inconvenient apparatus in the subsequent repolymerization. Furthermore, the large amounts of ethylene glycol necessitate low reaction temperatures, so that the added ethylene glycol does not escape disproportionately from the process. The low reaction temperatures lead in turn to high residence times with high cost and complexity of apparatus.

EP 0 174 062 A2 describes the depolymerization of polyester wastes in molten monomer (BHET and oligomers) with addition of ethylene glycol (ratio of rPET to EG=1:1.3-2.0) at moderate reaction temperatures (215 to 250° C.), and the subsequent repolymerization. With this process as well, large amounts of ethylene glycol are still needed, and must be removed again by costly and inconvenient apparatus in the subsequent repolymerization. Moreover, the amounts of ethylene glycol necessitate moderate reaction temperatures, so that the added ethylene glycol does not escape disproportionately from the process. The moderate reaction temperatures result in turn in high residence times, with high cost and complexity of apparatus.

U.S. Pat. No. 3,884,850 describes the depolymerization of high molecular mass polyesters in a continuous operation with minimally required stoichiometric amounts of ethylene glycol (10-15%) to give a low molecular mass oligomer mixture (average chain length unit=3) under atmospheric conditions, with subsequent repolymerization. Because of the low level of addition of ethylene glycol, the reaction temperature (220-250° C.) can be kept well above the boiling point of ethylene glycol (196° C.), for losses of evaporating ethylene glycol of around 10%. Moreover, a theoretical explanation is given of the relationship between low chain length and reduced melting point. A disadvantage of this operation, again, is a limited capacity. The melting of large amounts of polyester also necessitates large reaction volumes, given the required residence time of 1.5 to 3 hours.

John Scheirs and Timothy E. Long, in Modern Polyesters (May 2006 edition, pages 565-587), summarize the present status of the glycolysis processes: a glycolysis process can be carried out in stirred reactors with supply of molten PET and EG under pressure; the reaction rate can be increased by means of specific catalysts; PET can be melted in a mixture of PET flakes and EG; PET can be melted in an oligomeric mixture of partly glycolyzed PET; PET can be melted by addition of small amounts of EG through reactive depolymerization extrusion in extruders; all of the stated processes can also be carried out continuously.

Out of all the depolymerization processes, the simple glycolysis is the most effective process in terms of capital and operating costs, but has the disadvantage that large amounts of recycled PET can be added to a reactor only atmospherically, without complicated and expensive technology. At the same time, however, the amount of added ethylene glycol limits the maximum possible reaction temperature, since the ethylene glycol would otherwise escape through the filling apparatus. In principle, all depolymerization processes require large amounts of single-type and contamination-free PET wastes, in order to achieve good repolymerization results with high qualities, without costly and inconvenient purification processes.

To some extent, the present worldwide development of PET waste processing is already meeting these requirements, and from an environmental viewpoint there are further improvements likely in the near future.

Even low-level contamination of the recycled material with extraneous substances (e.g. other plastics, additives) in industrial PET plants may jeopardize the product quality (especially colour and/or viscosity) of the entire plant output, corresponding to the residence times over prolonged periods. Accordingly, a number of companies have developed processes for removing contamination of all kinds from the depolymerization process using technical facilities.

A customary process all along has been precision filtration or coarse filtration. Decolourizing with active charcoal is a new process. A technically different approach is the early recognition of unwanted contamination in the rPET supplied, and a rapid response thereto, with minimal resultant waste quantities and with identification of the rPET batch supply.

### PRESENTATION OF THE INVENTION

Starting from the prior art discussed above, therefore, it is an object of the present invention to specify an apparatus and a process for producing a polyester depolymer. The apparatus and the process are to be able to be realized extremely cost-effectively and with technical simplicity and therefore in a reliable way. It is an object of the present invention, moreover, to specify an apparatus for producing a polyester that allows the polyester depolymerizate generated in accordance with the present invention to be processed further into a polyester. The goal more particularly is a process which is optimized in terms of energy and substances and which is able to cover recycling rates of 25% to 100%, is able to produce high-quality products, and features low capital costs and operating costs.

This object is achieved with the features of the independent claims, the dependent claims relating to advantageous developments.

According to a first aspect, then, the present invention relates to an apparatus for producing a polyester depolymer, comprising
a mixing vessel having an inlet for solid polyester recyclatepolyester recyclate, an inlet for a liquid polyester depolymerizate and an outlet for a mixture comprising or consisting of the polyester recyclatepolyester recyclate and the polyester depolymer,
downstream of the outlet of the mixing vessel, at least one feed facility for a depolymerizing agent, and
downstream of the feed facility, a switch point for splitting the polyester depolymerizate stream into at least two substreams, with one substream being in communication with the inlet for the polyester depolymerizate of the mixing vessel, and the further substream or substreams serving for discharge of the polyester depolymerizate from the apparatus,
where all of the constituents of the apparatus are in fluid communication by means of a pipe conduit.

Upstream of the switch point there is preferably a reservoir vessel for temporary storage of the polyester depolymer.

According to a further preferred embodiment, downstream of the feed facility for a depolymerizing agent there is a mixer, more particularly a static mixer.

The depolymerizing agent may comprise further agents and/or additives which are advantageous for later modification of the polyester produced therefrom.

Downstream of the feed facility for a depolymerizing agent there may advantageously be a heating apparatus, preferably a heat exchanger, more particularly a shell-and-tube heat exchanger, preferably downstream of the mixer of the preceding claim.

It is preferred, moreover, if upstream of the inlet for the polyester recyclate there is at least one storage apparatus for storage of the polyester, for example at least one silo, which is in communication with the inlet for polyester recyclate of the mixing vessel more particularly via a conveying apparatus, for example a screw conveyor, star wheel, weighing device and/or supply shaft.

The mixing vessel and/or the reservoir vessel preferably has at least one facility for imposition of reduced pressure, the reduced pressure apparatus preferably possessing a spray condenser.

It is advantageous, furthermore, if the apparatus possesses at least one inert gas supply, which opens out for example into the storage apparatus, the conveying apparatus and/or the reservoir vessel.

The pipe conduit may preferably possess at least one conveying pump.

It is preferred, furthermore, if the mixing vessel
possesses at least one apparatus for mixing of polyester recyclate and polyester depolymer, for example a dynamic mixer, a screw pump and/or a jet mixer, which in particular has flat-jet nozzles, and/or
is free from active mechanical mixing devices, such as stirring members.

Within the pipe conduit there is preferably at least one apparatus for removal of particulate and/or chemical impurities, more particularly upstream of the discharging of the polyester depolymerizate from the apparatus and/or upstream of the reservoir vessel.

The at least one apparatus for removal of particulate and/or chemical impurities is preferably selected from the group consisting of particle filters, more particularly for removal of particles having a diameter <10 μm, activated carbon filters, ion exchangers, distillation and crystallization apparatuses, and combinations thereof.

Mixing vessel, switch point, pipe conduit and optionally reservoir vessel, mixer and heating apparatus may be of heatable and/or thermally insulated design, for example by means of a double-wall construction, within which a liquid or gaseous heat transfer medium may be carried.

The mixing vessel and/or the conveying apparatus preferably possess a pressure relief apparatus which at a mandated pressure diverts excess pressure from the apparatus, for example an overpressure valve and/or a bursting disc.

According to a second aspect, the present invention relates to a process for producing a polyester depolymer, wherein solid polyester recyclate is mixed with a liquid polyester depolymerizate and the mixture is converted into a melt, a depolymerizing agent is added at least once to the melt and reacted with the melt, to generate polyester depolymer, and then a substream of the polyester depolymerizate generated is used for mixing with the polyester recyclate, and the rest of the polyester depolymerizate is obtained as product.

The process of the invention may be carried out more particularly with the apparatus of the invention as described above.

In one preferred embodiment of the process
the liquid polyester depolymerizate on mixing with the polyester recyclate is fed at a temperature of 240 to 320° C., preferably 250 to 300° C., more preferably 260 to 290° C., and/or
the polyester recyclate on mixing with the polyester depolymerizate is fed at a temperature of −40° C. to 230° C., preferably 0° C. to 100° C., more preferably 10° C. to 50° C.

Surprisingly, it has been recognized that the thermal damage due to the considerably quicker melting at temperatures well above the melting point of the polyester recyclate is reduced advantageously by means of extremely short residence times. The higher temperatures required may be enabled here through the use of only small amounts of depolymerizing agent. The nitrogen inerting which is needed for safe plant operation is utilized at the same time to minimize the thermooxidative damage at the desired process temperatures.

The mixing is preferably effected by means of a dynamic mixer, a screw pump, a stirring mechanism and/or a jet mixer, particular preference being given to a jet mixer.

The mixing ratio (weight/weight) of polyester recyclate with polyester depolymerizate that is selected in the process of the invention is at least 1:5, preferably at least 1:2 or more preferably not more than 1:1.4.

The depolymerizing agent, based on the mass fraction of polyester recyclate, is added preferably in mass fractions of not more than 1:0.1 (depolymerizing agent), preferably not more than 0.05 (depolymerizing agent), more preferably not more than 0.01 (depolymerizing agent).

An advantage is that the lower the amount of depolymerizing agent added, the lower the amount of depolymerizing agent that must later be removed again at heightened cost and complexity of apparatus.

Preferably, in the process of the invention,
a residence time of the mixture, from mixing of the polyester recyclate with the polyester depolymerizate to adding of the depolymerizing agent, is set at 0.5 to 30 min, preferably 1 to 10 min, more preferably 2 to 5 min, and/or
a total residence time of ≤1.5 hours, preferably ≤60 min, more preferably
≤30 min is set.

The COOH end group concentration of the polyester depolymerizate withdrawn as product is advantageously not more than 250 mmol/kg, preferably not more than 150 mmol/kg, more preferably not more than 50 mmol/kg.

At the latest with the addition of the depolymerizing agent, the melt may be adjusted to an average degree of polymerization of less than 50, preferably less than 30, more preferably less than 20.

Preferably, after addition of the diol and before division into substreams, the melt is mixed, for example by means of a static mixer.

It is also possible for the melt to be heated, preferably to temperatures of 240 to 320° C., preferably 250 to 300° C., more preferably 260 to 280° C., more particularly by means of a heat exchanger, and with further preference the residence time of the melt during the heating is 1 to 30 min, preferably 2 to 20 min, more preferably 5 to 10 min.

With particular preference the depolymerizing agent is selected from the group consisting of diols, e.g. monoethylene glycol, diethylene glycol, triethylene glycol, polyethylene glycol, 1,3-propanediol, 1,4-butanediol, cyclohexanedimethanol and/or ethylene diglycol, more particularly a diol corresponding to the diol used for producing the original polyester, or from a mixture of different diols, water, organic acids, more particularly lactic acid, and also mixtures thereof, where the depolymerizing agent may comprise further additives. A diol corresponding to the diol used for producing the original polyester is the diol from which, in the polyester concerned, the corresponding alcoholic repeating unit is derived—in other words, for example, ethylene glycol for polyethylene terephthalate. In the case of polyesters which represent polylactones, such as polylactic acid, for example, it is likewise possible to use diols or the corresponding (open-chain) hydroxy acids derived from the parent lactones—in other words, for example, lactic acid for polylactic acid, etc.

Preferably the mixing is carried out under reduced pressure or atmospheric pressure, preferably under reduced pressure by application of a vacuum, where more particularly vapours drawn off by the vacuum are scrubbed out by means of a spray condenser.

Advantageously the polyester depolymerizate withdrawn as product is purified, preferably filtered and/or chemically purified, with particulate and/or chemical impurities being separated off. This may be done, for example, by means of particle filters and/or ion exchangers. Further possible cleaning steps are the treatment of the polyester depolymerizate with activated carbon, the distillation of the polyester depolymerizate in, for example, a thin-film evaporator, and/or the crystallization of the polyester depolymer.

The mixing, melting and reacting are carried out preferably in inert atmosphere with an oxygen content of <5 vol %, preferably <1 vol %, more preferably <0.1 vol %, more particularly a nitrogen atmosphere.

The polyester depolymerizate generated is preferably stored temporarily and/or collected and/or filtered before separation into substreams.

Preferably the polyester recyclate is rPET and the depolymerizing agent is the diol ethylene glycol, the polyester recyclate is rPBT (recycled polybutylene terephthalate) and the hydrolysing agent is the diol 1,4-butylene glycol, the polyester recyclate is rPTT (recycled polytrimethylene terephthalate) and the hydrolysing agent is the diol 1,3-propanediol, the polyester recyclate is rPBS (recycled polybutylene succinate) and the hydrolysing agent is the diol 1,4-butylene glycol, the polyester recyclate is rPEN (recycled polyethylene naphthalate) and the hydrolysing agent is the diol ethylene glycol, the polyester recyclate is rPEF (recycled polyethylene furanoate) and the hydrolysing agent is the diol ethylene glycol, or the polyester recyclate is rPLA (recycled polylactic acid) and the hydrolysing agent is water and/or lactic acid.

The polyester recyclate is fed preferably in the form of pellets and/or flakes.

The process may in particular be operated continuously.

An illustrative and especially preferred independent depolymerization process in multiple stages, wherein rPET through the mix-incorporation is partially hydrolysed into hot depolymer, monomer or prepolymer in a vessel and, during the subsequent melting with small amounts of EG in a heat exchanger, is glycolyzed, and the resulting depolymerizate is purified and polymerized into a high-grade polyester, is characterized by
a) exclusion of atmospheric oxygen by inertizing with N₂ for increasing the safety and quality,
b) a high melting and depolymerization temperature of 260 to 290° C., more preferably of 270° C., under virtually atmospheric conditions for the addition of rPET,
c) mass ratios of rPET to EG of not more than 1:0.25, preferably less than 1:0.1, more preferably less than 1:0.05,
d) residence times in the depolymerization of not more than 1.5 hours, preferably less than 60 min, more preferably less than 30 min,
e) low COOH end group concentration in the depolymerizate of not more than 150 mmol/kg, preferably less than 50 mmol/kg,
f) purification of the depolymerizate by means of filtration, optionally further purification by activated carbon, ion exchange, distillation/crystallization,
g) polycondensation or polymerization of the purified depolymerizate to give a high-quality polyester, or
h) diverse possibilities for incorporation into PET plants, such as, for example, the utilization of the energy supply with organic heating media from the ES stage. In this case the fraction of rPET employed reduces the required amount of PTA and EG in the ES stage, and the energy that is liberated as a result can be taken for melting of the rPET. The incorporation into existing reduced-pressure systems may be utilized in order to generate the required reduced pressure. Incorporation into existing EG metering systems may be practised. Existing monomer or prepolymer conduits can be utilized for filling the depoly plant.
i) Utilization of the existing processing stages for water and EG in a PET plant,
j) short reaction times to quality problems with rPET, with low levels of contamination volumes,
k) along with the possibility both of a preferred continuous operating mode and of a batch mode/operating mode referred to as batchwise.
l) Minimal start-up and run-down volumes, and an apparatus (rPET monomer jet mixer) for the cost-effective and efficient mix-incorporation of large volumes of rPET into hot monomer,
   with utilization of the tendency of rPET and liquid monomer to stick to one another
   mixers in general (e.g. a stirring mechanism, a dynamic mixer, screw conveyors) and preferably with utilization of the impact energy of one jet or two or more jets of liquid monomer, prepolymer or depolymer; rPET falling and/or pressed into these liquid jets is entrained and incorporated by mixing, and so the resultant mixture of partially melted rPET and liquid depolymerizate can be conveyed on from a small reservoir vessel using standard commercial conveying pumps, with the minimum mixing temperature of rPET and liquid depolymerizate always being established above the solidification range of this mixture.

According to a third aspect, the present invention relates to an apparatus for producing polyesters, comprising in series an apparatus of the invention as described above for producing a polyester depolymer, and at least one polycondensation stage.

The present invention makes it possible for example to retrofit an existing apparatus for producing polyesters with the apparatus for producing a polyester depolymer, or else to construct separate apparatuses for producing polyesters.

The apparatus for producing polyesters preferably comprises the stages described above, these being, for example,
at least one falling-film reactor or a preliminary polymerizer,
at least one disc reactor or a final polymerizer, and
optionally one or more apparatuses for carrying out a solid-phase post-condensation.

In a fourth aspect, the present invention relates to a process for producing polyesters, wherein initially a polyester depolymerizate is produced in the manner of the invention as described above, and this depolymerizate is subsequently polymerized to the polyester.

In this process, optionally, the prepolymerization stage may be skipped.

### DETAILED PRESENTATION OF THE INVENTION

The present invention is described in more detail with reference to the embodiments below, with reference to an illustrative recyclate operation using rPET, without restricting the invention to the specific embodiments presented.

### Terminology, Definitions

The definitions used below are general validity and are also employed for describing the present invention.

PET stands for polyethylene terephthalate, a polyester which can be produced in PET plants by esterification of the raw materials PTA (purified terephthalic acid) and EG (ethylene glycol) or to a lesser extent by transesterification of the raw materials DMT (dimethyl terephthalate) and EG, with subsequent polycondensation in either case. Rather than purified terephthalic acid, it is also possible to take less pure or impure terephthalic acid, provided that the desired quality of the end product is attained and physical properties of the PET plant are not adversely affected. PET is a macromolecule made up of numerous identical basic building blocks. The average degree of polymerization, hereinafter also called Pn or else average chain length, indicates the number of basic building blocks per PET molecule. Degree of polymerization in the sense of the present invention is synonymous with degree of polycondensation. For PET, the monomeric building block is —[OOC—C₆H₄—COO—(CH₂)₂]— with a molar weight of 192 g/mol. A Pn of 5 means that in the PET molecule there are five basic building blocks arrayed as in a chain. The molar weight of PET with a Pn of 5 is in that case 5×192 g/mol, plus the molar weight of the associated two end groups. The two end groups may each be one-OH from the ethylene glycol or one-COOH from the terephthalic acid, or the same end group twice. The higher the degree of polymerization, the more viscous the PET. Only when the Pn is sufficient and hence viscosity is sufficient can PET be processed into end products such as film, fibres or packaging materials. In this case the Wallace-Hume-Carothers equation for linear AA/BB systems is valid, which states that sufficiently high chain lengths are achievable only when the conversion of reacted COOH end groups is sufficiently high, in other words when only small amounts of unreacted COOH end groups are still present. The viscosity of PET is customarily reported as the intrinsic viscosity, called IV hereinafter, with the unit dl/g. For PET production it is necessary to add effective catalysts (e.g. antimony, titanium or aluminium compounds) so that the reaction times and hence the vessel sizes remain within economic bounds. A wide variety of different additives are added as well, examples being stabilizers, dyes, dyeing agents or other auxiliaries, in order to achieve particular properties.

PTA, DMT and EG are referred to as monomeric reactants. Chemical reaction first produces an intermediate, also called monomer. Moreover, it is also possible to generate comonomers by adding other dicarboxylic acids and other dialcohols, in order to achieve properties which deviate from those of the pure PET but are useful within sub-ranges. The PET formed in that case is also called co-PET.

Recycled PET, hereinafter referred to as rPET, or else “post-consumer recycling PET” (PCR-PET), is collected, cleaned and pelletized or comminuted PET or, generally, any form of PET after the first or repeated use after production in a PET plant. The rPET is preferably very largely of single kind and free from extraneous substances, as a result of the application of current processing methods. The comminution of the rPET may have been achieved by commonplace comminution methods, such as shredding or grinding; shredded bottle wastes are particularly preferred (as they currently account for the greatest fraction of available rPET in volume terms). rPET however, may also refer to comminuted intermediate (monomers, oligomers, prepolymers) from PET plants.

Depolymerizate: Depolymerizate or else PET depolymerizate refers to a mixture of >70% from short-chain PET macromolecules (i.e. monomers having degrees of polymerization of generally 1 to 25 of the PET monomer base unit C₁₀H₈O₄) which, moreover, may contain residues of other monomers, organic or inorganic additives, and extraneous substances. Other possible monomers may be formed from other added dicarboxylic acids such as isophthalic acid or adipic acid, for example, or from other diols such as diethylene glycol, cyclohexanedimethanol or butanediol, for example. Polyester depolymers in that case correspond to short-chain macromolecules of polyesters consisting of any desired and any desired number of different dicarboxylic acids and of any desired and any desired number of different diols. Depolymers or polyester depolymers are obtained preferably by hydrolysis and glycolysis, or, generally, by solvolysis of polyesters at elevated process temperatures.

A melt may be a pumpable mixture of rPET and depolymerizate or may consist only of a pumpable mixture of depolymer.

### PET Plant

A typical PET plant of the prior art for producing PET from the primary monomeric reactants PTA and EG essentially comprises six production stages. Here, multiple production stages may be amalgamated into individual reactors. An example is a 2R-PET plant from Uhde Inventa-Fischer for producing PET for films, fibres or packaging material, for example. All details of process parameters and product properties such as temperatures, pressures, IVs, COOH end group contents and degrees of polymerization, for example, are guide values. Slight deviations are possible and necessary according to formula and capacity.

Apart from esterification, transesterification and polycondensation stages, PET plants also contain processing stages for resultant reaction products such as water, methanol, EG and other by-products, for example. They may likewise be followed by stages for the processing of the polycondensation product into saleable product, such as pelletizing devices, more particularly strand or underwater pelletizing means, or there is direct attachment of spinning machines, preform machines or lines for the production of PET films or other PET end products. There may also be downstream conditioning devices and solid-phase polycondensation means for the purpose of reducing unwanted accompanying products such as acetaldehyde, for example, and for increasing the viscosity.

The first production stage is called simply the esterification stage (ES stage), as it primarily involves esterification of COOH end groups with OH end groups, producing water. Depending on the ratio in which PTA (HOOC—C₆H₄—COOH) and EG (HO—[CH₂]₂—OH) react with one another and the reaction conditions prevailing, a mixture of water and PET molecules with different numbers of basic building blocks and different end groups is obtained. Examples include the following:

HOOC—C₆H₄—COOH+HO—[CH₂]₂—OH⇄H₂O+HOOC—C₆H₄—COO—[CH₂]₂—OH(Pn=1,MW=210 g/mol) 1)

HOOC—C₆H₄—COO—[CH₂]₂—OH+HO—[CH₂]₂—OH⇄H₂O+HO—[CH₂]₂—OOC—C₆H₄—COO—[CH₂]₂—OH(Pn=1,MG=245 g/mol) 2)

HOOC—C₆H₄—COO—[CH₂]₂—OH+HO—[CH₂]₂—OOC—C₆H₄—COO—[CH₂]₂—OH⇄H₂O+HO—[CH₂]₂—OOC—C₆H₄—COO—[CH₂]₂—OOC—C₆H₄—COO—[CH₂]₂—OH(Pn=2,MW=446 g/mol) 3)

HOOC—C₆H₄—COOH+HOOC—C₆H₄—COO—[CH₂]₂—OH⇄H₂O+HOOC—C₆H₄—COO—[CH₂]₂—OOC—C₆H₄—COOH(Pn=1,MW=358 g/mol)5)etc. 4)

The mixture of the different PET molecules with different end groups from the ES stage is called a monomer, not to be confused with the PTA and EG raw materials likewise referred to as monomeric reactants. In the literature specifically the bishydroxyethylene terephthalate (BHET) with Pn=1 is referred to as monomer.

Short-chain PET molecules, especially the molecule with a Pn of 3, are also called oligomers. Because the esterification reactions are equilibrium reactions, it is necessary to draw off the resultant water from the reaction mixture in order to achieve high conversion rates. A 100% conversion rate here corresponds to the complete reaction of all available COOH end groups. The reverse reaction with water is referred to as hydrolysis. At the typical process conditions for the ES stage, with a supplied molar ratio of PTA to EG of around 1:1.6, a product temperature of around 265° C. and an absolute pressure of around 250 kPa, the monomer has an average Pn of around 4.2, with a residual concentration of COOH end groups of around 600 mmol/kg. The intrinsic viscosity (IV) according to ASTM is around 0.05-0.10 dl/g.

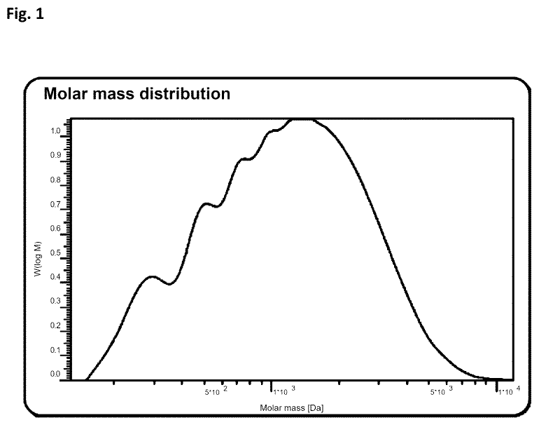

FIG. 1 shows a typical result of a GPC analysis of monomer from the ES stage. The mean molar mass (Mn) was found to be 802 g/mol. If the Mn is then divided by the 192 g/mol molar weight of the base unit (C₁₀H₈O₄), an average degree of polymerization of 4.2 is obtained.

From the ES stage, the water formed in the reaction is drawn off together with a fraction of supplied EG and, for separation, this mixture is supplied to a distillation column with attached water processing and off-gas processing. The esterification reaction does not require any additional catalyst, since the esterification reactions are autocatalysed by the acidic H⁺ ions of the terephthalic acid units.

The second production stage is called post-esterification (also post-ester or PE stage), since in this stage, by lowering of the pressure to an absolute pressure of around 60 kPa and increasing of the temperature to around 275° C., the conversion rate in the esterification is increased further, evident from the increase in the mean degree of polymerization, an increase in intrinsic viscosity to around 0.10-0.15 dl/g, and the further decrease in the COOH end group concentration to around 200 mmol/kg. The absolute pressure of around 60 kPa is generated by a vacuum system and the amounts of water of reaction that are drawn off and the amounts of EG that are liberated are supplied again for separation to a distillation column with attached water and offgas processing. The mixture of the various PET molecules from the PE stage is likewise called monomer. If this monomer is to be differentiated from the monomer of the ES stage, it is possible, for example, to include a reference to the production stage or to indicate the chain length. Typical average chain lengths of this monomer from the PE stage are between 5 and 15.

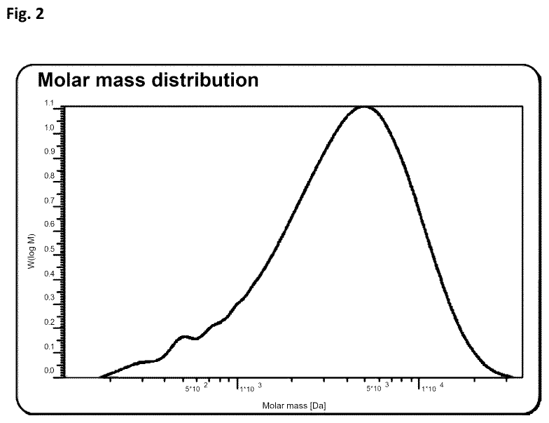

FIG. 2 shows a typical result of a GPC analysis of monomer of the PE stage. The mean molar mass (Mn) was found to be 2310 g/mol. If the Mn is then divided by the 192 g/mol molar weight of the base unit, an average degree of polymerization of 12.0 is obtained.

The third production stage is called preliminary polymerization or prepolymerization or else precondensation, PP stage for short. In this case the prevailing reaction is no longer the esterification of COOH and OH end groups, but rather the polymerization or else polycondensation reaction by transesterification of ester groups with liberation of ethylene glycol. The esterification reaction with liberation of water of reaction, however, still takes place to a small extent, evident from the further decrease in the COOH end groups. The polycondensation reaction requires a catalyst in order to achieve usable reaction rates. Established catalysts are Sb, Ti or Al compounds. In order to achieve usable reaction rates, the polycondensation also requires very low pressures, further increased temperatures, and thin diffusion layers, in order to allow the resultant EG to be removed.

The polycondensation reaction is also an equilibrium reaction, and the reverse reaction with EG is called glycolysis. The consequence of the polycondensation reaction is a further increase in the degree of polymerization with a rise in the intrinsic viscosity. The low pressure required is generated by a vacuum system, and the quantities of EG removed are supplied with traces of water, for separation, to a distillation column with attached water and offgas processing again. In the PP stage, with process conditions of 0.5-2 kPa and temperatures of 275-285° C., a further lowering of the COOH end groups to 60 mmol/kg and an increase in intrinsic viscosity to around 0.30 dl/g are achieved.

The mixture of the various PET molecules from the PP stage is called prepolymer.

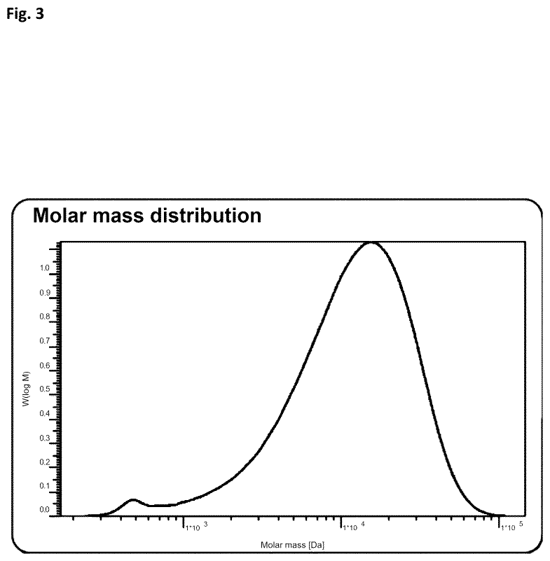

FIG. 3 shows a typical result of a GPC analysis of prepolymer of the PP stage.

The mean molar mass (Mn) was found to be 6330 g/mol. If the Mn is then divided by the 192 g/mol molar weight of the base unit, an average degree of polymerization of 33 is obtained.

The fourth production stage is called polymerization, polycondensation or final polymerization (referred to hereinafter as DIS stage). Here again, the prevailing reaction is the polycondensation reaction by transesterification of ester groups with liberation of EG. The low pressure required is generated by a vacuum system and the amount of EG removed is supplied with traces of water, for separation, to a distillation column with attached water and offgas processing again. The thin diffusion layers required are typically generated in specific reactors with rotating discs.

The reactors required for this purpose are generally called finishers or final polymerizers or specifically DISCAGE® reactor for the generation of particularly high intrinsic viscosities and/or particularly high degrees of polymerization in the polymer melt. The mixture of the various PET molecules from the DIS stage is called polymer.

In the DIS stage, with process conditions of 0.05-0.1 kPa and temperatures of 280-290° C., a further lowering of the COOH end groups to 10-30 mmol/kg is achieved. Depending on the intended use of the PET, an intrinsic viscosity increase to 0.55-0.85 dl/g, and/or a molar mass of around 15 000-30 000 g/mol, are established.

The fifth production stage is the processing of the polymer melt into solid and uniform pellets by means of strand or underwater pelletizing devices. The fifth production stage may also be the direct further processing of the polyester melt to form spun fibres, films, foils, preforms or other typical PET end products.

The sixth production stage comprises the aftertreatment of the pellets in order to increase the intrinsic viscosity and/or to reduce levels of accompanying substances such as acetalaldehyde, for example. Examples of typical designations for the sixth production stage are post-condensation plant, solid-phase condensation, SSP or conditioning.

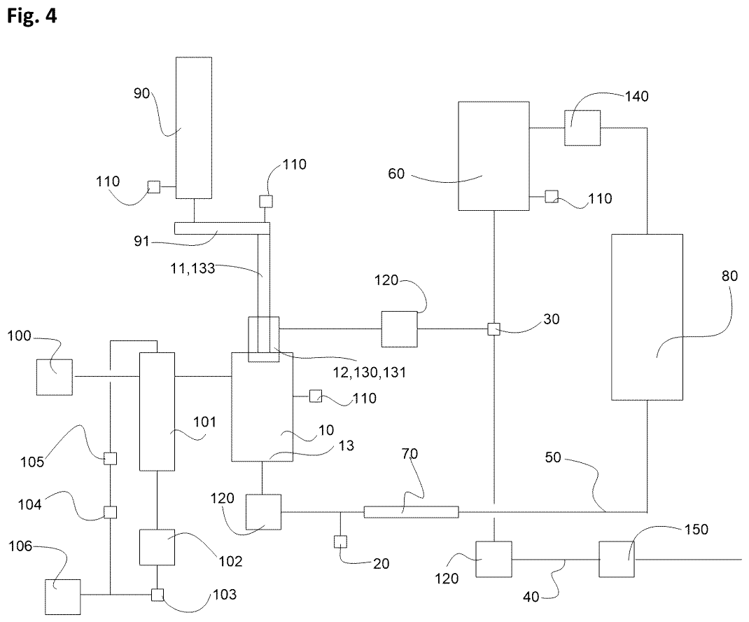

FIG. 4 shows an overall apparatus 1 for the implementation of polyester production, starting from polyester recyclate.

The apparatus for producing a polyester depolymerizate (depolymerization unit) consists of multiple stages.
a) Stage 1 comprises the storage (Silo 90) and supply device (screw conveyor 91) for rPET to the mixing stage (mixing vessel 10) with nitrogen inertizing 110,
b) Stage 2 is the mixing stage (mixing vessel 10) for the incorporation of rPET into liquid polyester depolymerizate in a reservoir for a conveying pump. Attached to stage 2 is a water spray system (spray condenser 101) for the deposition of the vapours drawn off, primarily water and low boilers, with attachment to a vacuum unit 100,
c) Stage 3 comprises the EG metering (feed facility for a depolymerizing agent 20),
d) Stage 4 comprises a heat exchanger 80 with possible downstream coarse filtration 140,
e) Stage 5 comprises the polyester depolymerizate reservoir vessel 60, which serves the mixing apparatus 10, with the molten excess being taken off into an existing PET plant, optionally with a fine filtration and emergency drainage apparatus.

Stage 1 comprises the storage and supply device for rPET. For this purpose, illustratively, the stage may comprise a silo 90, a metering screw 91 with weighing device, and a supply shaft to the mixing stage 10. For different rPETs—for example, pellets or flakes—stage 1 may also be present in duplicate or multiply, each specifically tailored to the storage and metering function for the different varieties of rPET that are used.

Preference is given to the addition of sufficient nitrogen as inert gas (by means of feed facilities 110 provided at various points) in order to minimize any possible introduction of oxygen by the rPET. The introduction of oxygen at high temperatures can lead, where there are sufficient amounts of ethylene glycol or other flammable gases present, to fire and a risk of explosion. Inherent plant safety can be ensured at below 5 vol % of oxygen; if this quantity is exceeded, the supply of rPET and ethylene glycol must be halted immediately. Even small amounts of introduced oxygen may lead to a considerable deterioration in the achievable colour at the temperatures used. The residual oxygen introduction ought therefore to be kept preferably below 0.1 vol %. In order to monitor the residual oxygen content in the rPET supplied, it is possible to install oxygen measuring cells in the rPET supply line and in the offgas from stage 2. The required amount of nitrogen is determined primarily by the amount of rPET supplied and by the reduced pressure required in stage 2 for suctioning off the resultant quantities of steam.

In order to be able to safely manage short-term excess pressure arising from rPET that is accidentally too wet—for example, PET wastes which have been rained on, unnoticed, wetly—it is possible, preferably at the supply shaft and at the reservoir vessel of stage 2, to provide a safety valve or a busting disc or a similar pressure relief facility.

Digital optical online entry control of the rPET is advantageous, as is the incorporation of rPET batch data and quality parameters into the continuous capture and evaluation of the operating data of the entire depolymerization unit.

Likewise advisable is an emergency drainage apparatus on the silo 90, in order to be able to drain rPET that has already been introduced to outside the depolymerization unit again.

The silo 90 is equipped advantageously with an outgoing-air filter and with level, temperature and pressure measuring means. The supply shaft is equipped advantageously with sight glasses and opening facilities and with level, temperature and pressure measuring means.

Stage 2 comprises the mixing of undried rPET at room temperature, for example, into liquid depolymerizate with a temperature of around 270° C. in a mixing vessel 10. Accordingly, for example, it is then possible for a suitable standard commercial conveying pump to convey this mixture onward without disruption through an attached pipe conduit. Stage 2 also includes an attached spray system 101 for deposition of the vapours drawn off (primarily water and other low boilers), and a connection to a vacuum system 100.

The incorporation by mixing of large amounts of rPET into liquid polyester depolymerizate may take place using commercial dynamic mixers or optimized screw pumps or optimized stirring mechanisms, or, most cost-effectively, with an apparatus which, utilizing the sticking tendency of rPET to liquid polyester depolymer, and utilizing the impact energy of one or more jets of hot, liquid polyester depolymer, entrains rPET that falls and/or is pressured into these depolymerization jets and incorporates it by mixing—this apparatus is referred to below as rPET depolymerizate jet mixer 131.

Stage 2 may advantageously be equipped with sight glasses and manholes, and also with level, temperature and pressure measuring means. From stage 2 to stage 5, the depolymerization unit, including pipe conduits 50, is heated on the jacket side. Particularly suitable for this purpose is a double-jacket design of containers and pipe conduits, which can then be heated with organic heat transfer media in liquid or, preferably, vapour form.

In very small plants, it would be possible for the sufficient mixing of rPET with liquid polyester depolymerizate in a vessel to be brought about additionally by a suitable stirring mechanism or by strong circulation pumps; in plants of the target magnitude, this procedure is disadvantageous from an economic and technical standpoint.

During the incorporation of rPET into liquid polyester depolymerizate by mixing, the intention is for a pumpable mixture of undissolved or slightly dissolved rPET and liquid polyester depolymerizate to be produced, which can be conveyed on from a small reservoir vessel using standard commercial conveying pumps. For this purpose the rPET is preferably to be present in the liquid polyester depolymerizate without significant voids. Voids present in a mixture would disrupt or prevent the conveying effect of standard commercial conveying pumps.

On incorporation of rPET into hot liquid polyester depolymerizate by mixing without significant further introduction of heat, it is also necessary to ensure that the higher heat energy of the hot polyester depolymerizate is transferred to the cold rPET (around room temperature). As long as the temperature of the hot depolymerizate or of the mixture is above the melting point or melting range of the rPET (typically around 245-250° C.), the latter will rapidly melt. If the mixing temperature is below the melting point of the rPET, the rPET remains in the partially melted but still solid state until the common lowest mixing temperature is reached. Partial melting of rPET particles here makes the rPET particles smaller and leads to a reduced required mass ratio of rPET to polyester depolymerizate for producing a conveyable mixture, and reduces frictional losses during conveying. The mixing temperature of rPET and polyester depolymerizate that comes about may be calculated approximately using the Riechmann mixing rule:

Tmix=(m₁*c₁*T₁+m₂*c₂*T₂)/(m₁*c₁+m₂*T₂)
where m=mass in kg,
c=specific heat capacity in KJ/kg and
T=temperature in ° C.).

For the present invention it is important here that, irrespective of how quickly the rPET and the polyester depolymerizate attain the mixing temperature that is established, the mixing temperature always remains above the solidification point or the solidification range of the mixture, in order to be able to rule out consequent plant disruption or plant damage events. Experimentally, the solidification range of various polyester depolymerizate rPET mixtures has been found to be around 185 to 195° C.

Mixing temperatures below can be calculated approximately, taking the specific heat capacity of rPET at 20° C. to be 1.05 KJ/kg/K and that of polyester depolymerizate at 270° C. to be 1.95 KJ/kg/K (C. W. Smith/M. Dole, J. Polymer Sci. 20, 1956):

| | Mass ratio of rPET to polyester depolymer | | | | |
|---|---|---|---|---|---|
| | 1.0:1.0 | 1.0:1.3 | 1.0:1.4 | 1.0:1.5 | 1.0:2.0 |
| Mixing | 183° C. | 197° C. | 201° C. | 204° C. | 217° C. |
| temperature | | | | | |

Accordingly, a minimum mass ratio of rPET to polyester depolymerizate should not be below 1:1.4 without safety measures, in order to provide a guaranteed avoidance of unplanned, but possible, solidification and hence considerable process disruption with possible plant damage.

In order to provide early recognition of increased load or possible damage on the conveying pump/conveying pumps 120, it/they ought to be equipped with pump vibration and oscillation alarms and, additionally, the power consumption of the drive motor ought to be monitored.

The mixing reservoir vessel 60 is advantageously run at low residence time (2-5 min), in order on the one hand to ensure a continuous conveying flow with standard commercial conveying pumps 120 and on the other hand to keep the temperature drop as low as possible until reheating takes place in the heat exchanger stage. A low residence time translates not only to small vessel sizes and, connectedly, into low capital costs, but also to improved product quality as a result of the absolute lowest thermal load over time. The overall residence time in the depolymerization unit and the general temperature profile of the process here are similar to the conditions to which monomers or prepolymers in PET plants are also typically subject. With the operating parameter of the mass ratio of rPET to polyester depolymer, it is possible, in combination with the achieved and set temperatures, with the design of the heat exchanger, and with the minimally required EG ratio, to carry out further optimization of the process.

PET or rPET is highly hygroscopic and usually contains 0.1-0.4 wt % of water. If, then, undried rPET comes into contact with hot polyester depolymer, the greatest part of the water present will evaporate in the mixing stage 10 at 270° C., and a small part of water will hydrolyse the rPET. In that case the long-chain PET molecules are cleaved randomly, the degree of polymerization goes down, and new COOH end groups are generated. In addition, any low boilers that are present but unwanted (impurities) in the rPET will also evaporate or be entrained with the evaporating water.

The mean molar mass (Mn) of one example, where rPET flakes were dissolved in polyester depolymer, was found to be 1290 g/mol. If the Mn is then divided by the 192 g/mol molar weight of the base unit, an average degree of polymerization of 6.7 is obtained. The low chain length and viscosity are the basis for effective flowability and low melting point of the polyester depolymer-rPET mixture. The mean molar mass which comes about as a result of the hydrolysis is heavily dependent, however, on the amount of water bound hygroscopically in the rPET or the amount of water supplied overall with the rPET. Moreover, the extent of the hydrolysis is influenced by how much of the water supplied leads to reaction with the rPET, this being also influenced by the plant design and the mode of operation.

Attached on the mixing stage 10 is a spray condenser 101 with water circuit for the deposition of the water vapours, with connection to a vacuum stage 100, of an existing PET plant, for example—preferably the vacuum stage of the post-esterification stage.

As a result it is possible in a targeted way to generate a reduced pressure in the mixing stage, which removes the resultant water vapours and other low boilers and excess nitrogen from the mixing stage. The reduced pressure may be set such that no water vapour or low boilers pass back through the feed section into the rPET supply line and into the silo. As is usual in the prior art, the spray condenser 101 is preferably connected to a collecting vessel 102. At the base of the collecting vessel 102 there is a conveying pump 103 with attached filter 104 for filtration, and a subsequent heat exchanger 105 for the sufficient cooling of the water circuit. The excess water with possible low boilers may then be supplied, for example, to the wastewater treatment stage 106 of an attached PET plant, or to a dedicated wastewater treatment stage.

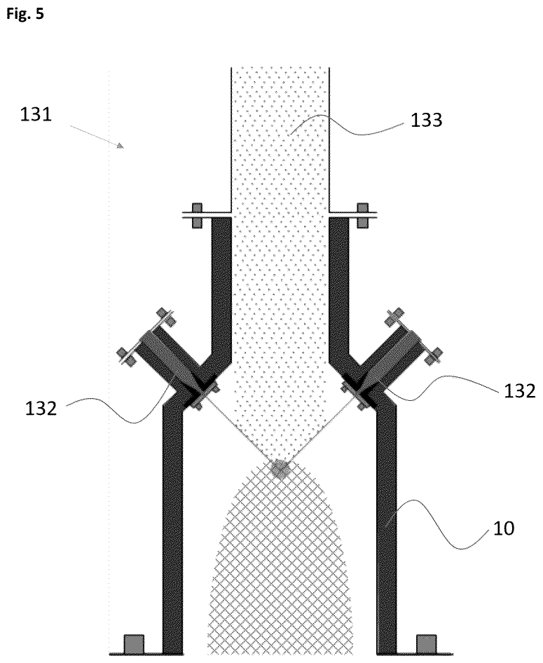

One possible version of the mixing apparatus 130 in the form of an rPET depolymerizate jet mixer 131 is represented in FIG. 5 and comprises a mixing vessel 10 inlet 11 in the form of a gravimetric rPET supply line 133, and two mutually opposed, downwardly inclined flat-jet nozzles 132, through which hot polyester depolymerizate is forced and sprayed. The sprayed polyester depolymerizate contacts the rPET falling into the mixing vessel 10.

The rPET supply line 11, 133 here is designed advantageously as a vertical round, square or rectangular supply conduit. The diameter selected here is at least sufficient to allow the entire quantity of rPET to be supplied in free fall without disruption. Additional nitrogen feeds may help to boost the supply of the rPET and to develop an opposing pressure to the resultant water vapour when the undried rPET is mixed in the hot polyester depolymer. The size of the arrangement of the two flat-jet nozzles 132 should be designed in accordance with the diameter of the rPET supply conduit, allowing all of the rPET to impinge in free fall on the flat jets. The velocity of the two flat jets here must be sufficient to accommodate the volume flow of rPET.

The higher the velocity of the two flat jets, the higher will be the impact forces for the mixing of the rPET with the polyester depolymer. The flat jets are bounded at the sides by the vessel walls. An alternative version is a funnel-like arrangement with four polyester depolymerizate jets.

The rPET volume flow which can be accommodated by the polyester depolymerizate jets is a product of the average layer thickness of rPET on the polyester depolymerizate jets, multiplied by the width of the polyester depolymerizate jets on which the rPET can fall, and multiplied by the velocity of the polyester depolymerizate jets:

V′=h*w*v
V′=rPET volume flow in m³/s
h=average entrained layer thickness of rPET on the polyester depolymerizate jet, in m
b=width of the polyester depolymerizate jets on which rPET can fall, in m
v=velocity of the polyester depolymerizate jets in m/s

The average layer thickness of rPET that is established on the polyester depolymerizate jets is favoured positively by the high tendency of rPET and hot liquid polyester depolymerizate to stick to one another. Another positive factor is the weight force of an rPET column standing on the polyester depolymerizate jets. Addition of nitrogen to the supply shaft may increase the pressure on the mixing of the rPET into the polyester depolymer, if the pressure loss above the addition screw is higher. It is also possible for rPET to be forced in a targeted way via a screw feeder 101 into the polyester depolymerizate jet or jets. The crossed and downwardly directed spraying direction sets the direction of the mixture, together with the downwardly acting gravitational force. One advantageous version here is the 45° downwardly directed inclination of the flat nozzles 132. The velocity of the emerging polyester depolymerizate jets is dictated by the volume flow of polyester depolymerizate and by the slit width and slit height of the nozzle geometry, where the slit height lastly selected dictates the maximum permitted size of solid and soluble constituents in the rPET, or the coarse filtration fineness that is required at least for this rPET.

v=V′/A
v=velocity of the polyester depolymerizate jets in m/s
V′=rPET volume flow in m³/s
A=nozzle outlet area (slit width in m×slit height in m)

The slit outlet area, together with the entry geometry of the nozzles 132, determines the pressure drop over the nozzles 132, which must be applied by the pump from the polyester depolymerizate reservoir vessel to the second stage. The slit nozzles 132 should advantageously be mounted on the unit in such a way as to be readily exchangeable, in order to enable responses to different capacities and rPET grades. It is also advantageous to use robust and wear-resistant materials such as hardened stainless steel for the nozzles 132.

Stage 3 comprises the addition via the feed facility for a depolymerizing agent 20, more particularly a diol (in the example case, EG), of extremely small amounts, not more than 0.1, preferably less than 0.05, more preferably less than 0.01 kg of EG per kg of rPET when hydrolysis has taken place, the viscosity and/or degrees of polymerization already being lower than those originally present in the rPET. The addition of EG here serves only incidentally to achieve a further reduction in the degree of polymerization, instead serving primarily to control the esterification of the COOH end groups, so that the subsequent repolymerization leads rapidly to high degrees of polymerization and the resultant polyester depolymerizate can be added preferably to the PP stage of an attached PET plant. The reaction of the EG with the rPET/polyester depolymerizate mixture takes place preferably at high process temperatures, through esterification reactions, within a few minutes. In this case, with the reaction, there is also a build-up in the pressure again, this pressure resulting from the evaporation of the EG in the hot polyester depolymerizate—at 270° C., max. about 6.4 bar absolute. The EG required may be withdrawn from a suitable tapping point from a PET plant. A sampling point may be provided upstream and/or downstream of the incorporation by mixing of the EG.

For improved distribution of the EG in the rPET/polyester depolymerizate mixture, it is possible downstream of the injection, at one or preferably two or more injection sites, to include a suitable mixing section (mixer 70) with low residence time, although the mixing section must not hinder the passage of the as yet unmelted rPET or impurities contained.

Stage 3 may be equipped advantageously with flow, temperature and pressure measuring means.

Stage 4 comprises a heat exchanger 80, with which the melting energy needed for the rPET can be provided. The heat exchanger 80 may be configured cost-effectively as a shell-and-tube heat exchanger, since the low viscosity of polyester depolymerizate permits effective heat transfer. The dimensioning of the heat exchanger is determined by the minimum residence time required and by the quantity of energy supplied per unit time. The minimum residence time required is a product of the time required to reheat the rPET/polyester depolymerizate mixture to around 270° C., plus the melting time in which the remaining unmelted rPET melts. At 270° C., given sufficient supply of heat, rPET dissolves completely within around 5 to 10 min. Mixing during the transport process and/or during flow, and/or the use of small rPET particles, are advantageous here. Intensive mixing during flow can be achieved, for example, by pipes equipped with an irregular surface (e.g. depressions), especially when such pipes are used in the heat exchanger. In part and for short periods, however, the mixture can also be superheated.

A sampling valve may be installed downstream of the heat exchanger. The heating power needed to melt the rPET is supplied by the heat exchanger; the rest of the unit is trace-heated. The heating power liberated from the esterification stage (as a result of the reduction in added PTA and EG by the fraction of added rPET) may be taken directly in the form of liquid, hot, organic heat-transfer oils for the operation of the heat exchanger 80. It is, however, also possible to use a dedicated heating stage, if the heat exchanger 80 is to be operated at particularly high heating-medium temperatures, e.g. 320° C. or more, in order to keep the required heating area as small as possible. Stage 4 may advantageously be equipped with viscosity, temperature and pressure measuring means.

The heat exchanger 80 may be configured advantageously in multiple stages, in order to control the different introduction of heat required for different capacities. In that case each stage may have a different geometry, heating temperature and heating area and may therefore be heatable individually. Advantageously, the first internal heat exchanger stage after stage 3 in this case has the highest heating temperature, and, where appropriate, the greatest heating area, and the last internal heat exchanger stage before stage 5 has the lowest heating temperature.

If an rPET-polyester depolymerizate jet mixer 131 is used in stage 2, a coarse filter 140 can be fitted downstream of the heat exchanger 80. The filtration fineness 140 must in this case be finer than the slit width of the nozzles used.

Stage 5 comprises a vessel (polyester depolymerizate reservoir vessel 60) in which the melted mixture of rPET and polyester depolymerizate is heated to around 270° C., depressurized as it comes from the heat exchanger 80, and stored temporarily with minimal residence time. From the polyester depolymerizate reservoir vessel 60, stage 2 is supplied using a conveying pump 120 customary for this purpose. The conveying volume of this pump 120 determines/controls the maximum permitted amount of rPET supplied, based on the minimum required mixing ratio, according to the volumetrically required ratio, the safety margin relative to the solidification temperature, and the form/consistency of the rPET.

The polyester depolymerizate excess, formed as a result of the melting of the rPET and evident from the steady rise in level in the depolymerizate reservoir vessel in continuous operation, is separated off via the switch point 30 and the take-off line 40, and is conveyed with a further pump 120 to an optionally attached PET plant. In this case, further filtration stages or purification stages 140, such as a fine filter, for example, may be inserted into the process flow. This pump 120 may be set up advantageously at the lowest point in the depolymerization unit, thus allowing the unit to be emptied at low points and of residual material when the unit is shut down. The polyester depolymerizate excess is fed into the stage of the attached PET plant that corresponds to the degree of polymerization attained—for example, directly into the PP stage.

Given regular sampling, the sampling sites allow contaminations that pose a risk to product quality to be promptly detected visually or by optical measurement methods. In that case there may be an emptying facility provided for the entire depolymerization unit. Emptying may take place, for example, into waste trucks with capacities of around 1 m³, into which around 200 L of water are introduced prior to filling. Water vapours produced are drawn off by suction and passed into the open air. The polyester depolymerizate must then cool in the waste trucks for further use. The low residence times and hence polyester depolymerizate volumes of the depolymerization unit limit the amount of waste to a minimum. The possibly attached PET production plant, with greater capacities and longer residence times, is therefore very largely protected from contamination. In that case, additionally, it is necessary to remove the defective batch from the rPET supply silo 90 as well, before regular operation can be resumed.

The polyester depolymerizate reservoir vessel 60 may also be used, in particular, for the start-up of the plant. From an optionally attached PET plant, hot, liquid monomer or prepolymer can be withdrawn until the depolymerization unit is full and the circular process can be started. Then the addition of rPET is started, the polyester depolymerizate is generated, and the excess polyester depolymerizate is run to the PET plant.

Stage 5 is preferably connected to the vacuum stage of the post-esterification stage of the optionally attached PET plant. This allows a slight reduced pressure to be generated in the monomer reservoir vessel and for any remaining low boilers or small amounts of liberated ethylene glycol to be drawn off and processed. Stage 5 may be equipped advantageously with sight glasses and manholes, and also with level, temperature and pressure measuring means and with nitrogen inertization.

### Analytical Methods Used

### Determination of the Number-Average Molar Mass Mn:

A gel permeation chromatography (GPC) allows molecules of dissolved compounds to be separated on the basis of their hydrodynamic volume. By comparing the retention time or elution volume of a molecule of unknown molar mass, it is possible to determine the unknown molar mass and molar mass distribution through comparison with the retention times/elution volumes of molecules of known molar mass. From the elution curve, after appropriate calibration, the distribution curve of the molar masses is obtained, and also enables calculation of the differently weighted mean molar masses. Mn here represents the number-average molar mass and shows the average molar mass of a polymer sample. If Mn is divided by the molar weight of the monomeric base unit of the polymer, the average number of monomeric base units is obtained, which is also called degree of polymerization (Pn).

### GPC Method:

The determination of molar masses by means of GPC takes place in accordance with DIN 55672-1 (2007) after calibration with polymethyl methacrylate standards (PMMA).

### Analysis Conditions:

Eluent: hexafluoroisopropanol (HFIP)/0.05 M potassium trifluoroacetate (KTFAC)
Columns: PSS PFG, 7 μm, 100 Å, ID 8.0 mm×300 mm, PSS PFG, 7 μm, 100 Å, ID 8.0 mm×300 mm, PSS PFG, 7 μm, 300 Å, ID 8.0 mm×300 mm.

Pump regulated to a flow rate of 1.0 mL/min; 50 μL injection volume with a sample concentration of 3.0 g/L. Detection with a differential refractometer (RID), evaluation with WinGPC software.

The molar mass averages and their distribution are calculated by means of the strip method with computer assistance, based on the PMMA calibration curve. The molar masses determined here are not absolute molar masses, but rather PMMA-equivalent molar masses.

### Determination of the Intrinsic Viscosity (IV)

The determination of the intrinsic viscosity is also called determination of the relative solution viscosity and is a standard method in quality control in the context of PET production. The intrinsic viscosities ascertained correlate with the degree of polymerization and with the mean molecular weight.

The intrinsic viscosity is determined in accordance with ASTM 4603-03 (2003) on a 0.5 wt % sample solution in a mixture of six mass fractions of phenol and four mass fractions of 1,1,2,2-tetrachloroethane, by determining the transit times of solvent mixture and solution in an Ubbelohde capillary viscometer of DIN type 1a (capillary diameter 0.95 mm) at 30° C.

The following equation gives the relative viscosity ηᵣₑₗ of the sample:

$${η}_{rel} = \frac{t - Δ t}{{t}_{0} - Δ {t}_{0}}$$

t: sample transit time [s]
Δt: Hagenbach correction time for the sample [s]
t₀: solvent mixture transit time [s]
Δ t₀: Hagenbach correction time for the solvent mixture [s]

The intrinsic viscosity of the sample is given by the following equation:

$$I . V . = \frac{0.25 * ( {η}_{rel} - 1 + 3 * ln {η}_{rel} ) \vert}{c}$$

c: sample concentration [g/dl]

### Determination of the COOH End Groups

The determination of the COOH end groups is also called determination of the carboxyl end groups and is a standard method in quality control in the context of PET production.

The COOH end groups are determined in accordance with ASTM D7409-15 by dissolving 0.25-0.5 g of polyester at 80° C. in 15 mL of o-cresol followed by dilution with 60 mL of dichloromethane, with titration with a 0.01 normal solution of KOH in methanol, by determining the changeover point of the added tetrabromophenol blue indicator, using an automatic titrator with attached optical sensor.

The determination of the amount of carboxyl groups (COOH) is given according to the following equation:

COOH=(Vs−Vb)*1000*M*f/W [mmol/kg]
Vs: volume of KOH solution needed to titrate the sample
Vb: volume of KOH solution needed to titrate the solvent mixture (blank value)
M: molarity of the KOH solution in methanol
f: factor of the KOH solution in methanol
W: mass of the weighed-out sample

### Experimental Apparatus for the Examples

The experimental apparatus provided was a heatable 5 L autoclave with stirrer. The heating operates with an organic heat transfer oil (Marlotherm SH) with 4 KW heating power. The autoclave can be charged with nitrogen. The stirrer is designed specifically for low- and high-viscosity PET products and, through high-efficiency surface renewal, is able, under suitable vacuum and temperature conditions, to generate PET viscosities of up to 1500 Pas dynamic viscosity, corresponding approximately to an IV of 0.85 dl/g at 275° C. Attached to the autoclave in series are two condensers. The first condenser serves as a simple separating stage for mixtures, in order, for example, to keep ethylene glycol in the reactor and allow water formed to escape. The second condenser then condenses all of the drawn-off gases in accordance with the cooling-medium temperature used. Downstream of the condensers there may be a vacuum pump, to enable the necessary vacuum for a polycondensation of monomer to polymer. In order to improve the vacuum performance of the vacuum pump, a cold trap operated with low-temperature liquid nitrogen may additionally be placed ahead of the pump. Located in the cover of the autoclave is an M36 sampling screw, which also enables the events in the reactor to be observed visually.

### Example 1

1000 g of standard commercial rPET flakes from shredded bottle waste were dried in the autoclave overnight at a heating temperature of 165° C. and with nitrogen charging. The stirrer ran at 20 rpm with a fluctuating torque of

2-8 Nm. To produce depolymerizate from the flakes, 100 g of ethylene glycol were introduced into the autoclave. The pressure in the autoclave was adjusted with N₂ to 4.0 bar (absolute).

The first condenser was set at 200° C., so that essentially only water can evaporate, whereas ethylene glycol condenses and drips back into the autoclave. The second condenser was operated with cooling water at around 10° C.

The heating (autoclave wall) was then adjusted from 165 to 300° C. target temperature. Just 10 min later there was a massive change in torque from

2-8 Nm to 9.4-10.5 Nm, indicating the start of the melting of the flakes. After 10 min the heating temperature was 262° C., and the product temperature (mixture of melted and undissolved flakes) was just 196° C.

20 min later, the heating temperature had risen to 300° C. and the product temperature, at 254° C., was already above the typical flake melting range of 245-251° C. The fact that at this point the flakes were already very largely melted is also indicated by the torque at 50 rpm, which had dropped sharply to 0.2-0.3 Nm.

After 50 min, the pressure was let down at a product temperature of 268° C. and a sample was taken from the autoclave. Laboratory analysis gave a viscosity of 0.142 dl/g.

A further 500 g of flakes were then added to the depolymerized flakes within one minute. In this case there was no change in the torque. However, for 6 min, the addition resulted in a lowering of the product temperature to 257° C., and at the same time the heating temperature fell from 298 to 297° C. The process regime in this case was isothermal; the heat losses were compensated by further heating. After 6 min, all of the flakes had then melted, since both the product temperature and the heating temperature began to climb again. 20 min after the addition of the 500 g of flakes, a sample was taken from the autoclave. Laboratory analysis gave a viscosity of 0.158 dl/g. The mean molar mass (Mn) of this sample was found by GPC measurement to be 1290 g/mol, corresponding to an average Pn of around 7.

The depolymerizate obtained was then subjected to polycondensation in the autoclave at around 270° C. and 0.7 mbar. No additional catalysts or other, further additives or auxiliaries were added. With increasing viscosity, the speed of the stirrer was lowered from 150 to 50 to 10 rpm. Over the course of 1.75 hours, the viscosity was increased in a decidedly linear way from 0.158 to 0.492 to 0.626 to 0.918 dl/g.

### Example 2

For example 2, standard commercial MTR® spherical PET pellets with an average pellet weight of 16 mg and a viscosity of 0.84 dl/g were used.

The empty autoclave was charged with 1000 g of pellets and 100 g of ethylene glycol. The torque of the stirrer thereafter was around 0.7 Nm at 100 rpm. The pressure in the autoclave was adjusted with N2 to 4.0 bar (absolute). The first condenser was set at 200° C., so that essentially only water can evaporate, while ethylene glycol condenses and drips back into the autoclave. The second condenser was operated with cooling water at around 10° C.

The heating was then adjusted from around 25 to 290° C. target temperature. It took only 20 min for the heating temperature to reach 250° C. At this point in time, as a result of the incipient melting process, the torque rose from around 0.7 to 4 Nm. After a further 10 min, the increase in the torque was over and a low, stable display of 0.3 Nm was achieved for a product temperature of around 260° C.

The pressure was then let down and the autoclave was opened for sampling. It could be seen that the pellets had completely melted. Laboratory analysis of the depolymerizate gave an intrinsic viscosity of 0.082 dl/g and 25 mmol/kg COOH end groups.

The heating was then halted for an adiabatic regime, and a further 500 g of pellets were added through the opened sampling aperture. Following the addition, the sampling aperture remained open, allowing the further melting procedure to be observed visually.

Following the addition of the pellets to the hot depolymerizate at 262° C., the granular pellets could clearly be seen to float in the clear melt, and also became visibly smaller within the first minutes. With the start of addition of the pellets, there was a continuous reduction in the product temperature. When the product temperature had dropped below around 245° C., there was no longer any change in the size of the granular pellets. 15 min after the addition, the product temperature had dropped to around 200° C. and the mixture of monomer and granular pellets became hazy. 20 min after the addition, the temperature reached 183° C. and the torque, which up to this point had shown a stable 0.35 Nm, suddenly climbed steadily to 1.2 Nm. At this point, the heating was re-engaged and the temperature drop was halted 25 min after the addition at 176° C. 40 min after the addition, the product temperature had reached 260° C. again, the granular pellets were all dissolved, and the melt was clear again. A sample was taken from the autoclave. Laboratory analysis gave an intrinsic viscosity for the depolymerizate of 0.087 dl/g and 25 mmol/kg COOH end groups.

The depolymerizate obtained was subsequently subjected to polycondensation in the autoclave at around 270° C. and 0.7 mbar. No additional catalysts or other, further additives or auxiliaries were added. With increasing viscosity, the speed of the stirrer was lowered from 150 to 50 to 10 rpm. Over the course of 1.5 hours, the intrinsic viscosity was increased from 0.087 to 0.203 to 0.407 to 0.570 to 0.672 to 0.787 to 0.886 dl/g.

### Example 3

For example 3, standard commercial MTR® spherical PET pellets with an average pellet weight of 16 mg and a viscosity of 0.84 dl/g were used.

The empty autoclave, but heated to 290° C., was charged with 1000 g of undried pellets with a temperature of around 25° C. The addition aperture remained open after the addition of pellets, allowing the further melting procedure to be observed visually.

After just 5 min, the first granular pellets underwent significant partial melting, leading for a short time to very high torques of up to 25 Nm. 10 min after the addition, the majority of granular pellets, at a product temperature of 247° C., had already undergone considerable melting and the torque had fallen to 2 Nm. 15 min after the addition, all of the pellets had melted, the product temperature was 261° C., and the torque was 0.7 Nm.

A sample was taken from the autoclave. Laboratory analysis gave an intrinsic viscosity of 0.26 dl/g and 41 mmol/kg COOH end groups.

In contrast with the two previous experiments, this experiment makes it clear that the rate of dissolution of rPET in hot monomer is dependent primarily on the temperature used, and this temperature must in every case be above the melting range of the rPET used. At temperatures above the melting point and under pressure (vapour pressure of the EG at the melting temperature used), a small added amount of EG can be converted within a few minutes into additional chain scission of the rPET, with a further reduction in viscosity and reduction in the COOH end groups. The addition of EG also reduces the internal friction of the rPET/monomer mixture during melting, apparent in the experiments from the lower torques occurring when the rPET is melted under pressure together with a little EG.

### Example 4

For example 4, standard commercial PTA and standard commercial EG were used for PET production, first to produce around 1000 g of a low molecular mass PET corresponding to a depolymer, followed by the dissolution therein of rPET flakes at 290° C., with subsequent determination of the solidification point of this mixture through a reduction in the heating.

The autoclave was charged with 778 g of PTA and 422 g of EG at room temperature, which were mixed at 100 rpm to form a paste. No additional catalysts or other, further additives or auxiliaries were added. The pressure in the reactor was then adjusted with N₂ to 2.6 bar absolute and the heating was started with a target temperature of 290° C. The first condenser was set at 160° C., so that water formed at 2.6 bar can be discharged, whereas evaporating ethylene glycol is able very largely to condense back into the reactor again. The second condenser was operated with cooling water at a temperature of around 10° C.

30 min after the start of the heating, the heating temperature was a constant 290° C. and the product temperature was 223° C., and the first distillate dripped back from the condenser 1, indicating the start of the esterification reaction. 110 min later, the yield of distillate from condenser 2 stopped, the esterification reaction was at an end, and the product temperature was 264° C. The heating temperature was then adjusted to 325° C. and condenser 1 to 210° C. 15 min later, the heating temperature was 325° C., the product temperature was 295° C., and the temperature of condenser 2 was 210° C. The pressure in the autoclave was then let down to atmospheric conditions and the autoclave was opened through the sampling aperture. A sample was taken from the autoclave. Laboratory analysis gave an intrinsic viscosity of 0.078 dl/g and 82 mmol/kg COOH end groups.

This was followed by the addition of 500 g of flakes within a minute at atmospheric conditions; the melting operation was observable through the sampling. The water vapours formed were drawn off by a slight reduced pressure. The flakes dissolved completely within 5 min, causing the product temperature to drop to 279° C., before climbing back to 287° C. again within the next 5 min. A sample was taken from the autoclave. Laboratory analysis gave an intrinsic viscosity of 0.103 dl/g and 100 mmol/kg COOH end groups.

The heating temperature was then adjusted to a setpoint 200° C., and both heating temperature and product temperature began to drop steadily. 40 min later, the heating temperature had dropped to 202° C. and the product temperature to 194° C. At this point in time, the melt became hazy and the torque of the stirrer began to rise, having previously always displayed a constant 0.4 Nm. A further 6 min later, at a product temperature of 184° C., the depolymerizate had solidified as a whole and was circulated by the stirrer in the form of a clot. This was possible because the stirrer is massively powered and the solidified depolymerizate falls apart easily.

### Example 5

Implementation was as in example 4, but 2000 g of flakes were incorporated by stirring over the course of 12 min into the around 1000 g of low molecular mass PET produced, and dissolved therein.

The flakes dissolved within 15 min from the start of the addition, but with a brief rise in the torque to 2 Nm. When the flakes had melted, a stable torque of 0.35 Nm was re-established.

The heating temperature was then adjusted to a setpoint 200° C., and both heating temperature and product temperature began to drop steadily. 32 min later, the heating temperature had dropped to 203° C. and the product temperature to 196° C., and the depolymerizate suddenly solidified as a whole.

1-19. (canceled)

20. A method for producing a polyester depolymerizate, the method comprising:
mixing solid polyester recyclate with a liquid polyester depolymerizate;
converting the mixture into a melt;
adding a depolymerizing agent at least once to the melt and reacting with the melt to generate a polyester depolymerizate;
using a substream of the generated polyester depolymerizate for mixing with the polyester recyclate; and
obtaining a remainder of the polyester depolymerizate as product.

21. The method of claim 20 wherein at least one of the liquid polyester depolymerizate on mixing with the polyester recyclate is fed at a temperature of 260 to 290° C. and the polyester recyclate on mixing with the polyester depolymerizate is fed at a temperature of 10° C. to 50° C.

22. The method of claim 20 wherein the mixing is effected by means of one of a dynamic mixer, a screw pump and a jet mixer.

23. The method of claim 20 wherein the mixing ratio (weight/weight) of polyester recyclate with polyester depolymerizate is not more than 1:1.4.

24. The method of claim 20 wherein the depolymerizing agent, based on one weight fraction of polyester recyclate, is added in weight fractions of not more than 1:0.05 (depolymerizing agent).

25. The method of claim 24 wherein a residence time of the mixture, from mixing of the polyester recyclate with the polyester depolymerizate to adding of the depolymerizing agent, is set at 2 to 5 min, and a total residence time of ≤30 min is set.

26. The method of claim 20 wherein the COOH end group concentration of the polyester depolymerizate withdrawn as product is not more than 50 mmol/kg.

27. The method of claim 20 wherein the melt of the mixture of the polyester recyclate and the polyester depolymerizate, before addition of a depolymerizing agent, is adjusted to an average degree of polymerization of 5 to 15.

28. The method of claim 27 wherein the melt, after addition of the depolymerizing agent and before division in substreams is mixed, by means of a static mixer and wherein the melt is heated to temperatures of 260 to 280° C., by means of a heat exchanger, and with further preference the residence time of the melt during the heating is 5 to 10 min.

29. The method of claim 20 wherein the depolymerizing agent is selected from the group of diols including monoethylene glycol, diethylene glycol, triethylene glycol, polyethylene glycol, 1.3-propanediol, 1.4-butanediol, cyclohexanedimethanol,

30. The method of claim 20 wherein the diol corresponds to a diol used for producing the original polyester, or from a mixture of different diols, water, organic acids, more particularly lactic acid, and also mixtures thereof, where the depolymerizing agent may comprise further additives.

31. The method of claim 20 wherein the mixing is carried out under reduced pressure or atmospheric pressure, preferably under reduced pressure by application of a vacuum, where more particularly vapours drawn off by the vacuum are scrubbed out by means of a spray condenser.

32. The method of claim 20 wherein the polyester depolymerizate withdrawn as product is purified, filtered and/or chemically purified, distilled or crystallized, with particulate and/or chemical impurities being separated off.

33. The method of claim 20 wherein the mixing, melting and reacting are carried out in inert atmosphere with an oxygen content of <0.1 vol %, and in a nitrogen atmosphere.

34. The method of claim 20 wherein the generated polyester depolymerizate is stored temporarily and/or collected before separation into substreams.

35. The method of claim 20 wherein the generated polyester depolymerizate is filtered.

36. The method of claim 20 wherein the polyester recyclate is rPET and the depolymerizing agent is the diol ethylene glycol, the polyester recyclate is rPBT (recycled polybutylene terephthalate) and the depolymerizing agent is the diol 1.4-butylene glycol, the polyester recyclate is rPTT (polytrimethylene terephthalate) and the depolymerizing agent is the diol 1.3-propanediol, the polyester recyclate is rPBS (recycled polybutylene succinate) and the depolymerizing agent is the diol 1.4-butylene glycol, the polyester recyclate is rPEN (recycled polyethylene naphthalate) and the depolymerizing agent is the diol ethylene glycol, the polyester recyclate is rPEF (recycled polyethylene furanoate) and the depolymerizing agent is the diol ethylene glycol, or the polyester recyclate is rPLA (recycled polylactic acid) and the depolymerizing agent is at least one of water and lactic acid.

37. The method of claim 20 wherein the polyester recyclate is fed in the form of pellets and/or flakes and/or comminuted rPET.

38. The method of claim 20 wherein the method is carried out one of continuously and batchwise.

39. The method of claim 20 wherein a polyester depolymerizate is produced by means of a process according to claim 20 and is subsequently polymerized to give polyester.
